(19) United States
(12) Patent Application Publication
(10) Pub. No.: US 2018/0178463 A1
(43) Pub. Date: Jun. 28, 2018

(54) 3D PRINTING SYSTEM WITH VACUUM CHAMBER ENCLOSURE & RELATED METHOD

(71) Applicant: Kayvon Manian, Coto de Caza, CA (US)

(72) Inventor: Kayvon Manian, Coto de Caza, CA (US)

(21) Appl. No.: 15/392,870

(22) Filed: Dec. 28, 2016

(51) Int. Cl. B29C 67/00; B33Y 10/00; B33Y 30/00; B33Y 50/02

(52) U.S. Cl. CPC B29C 67/0085; B29C 67/0055; B29C 67/0088; B29K 2105/0067; B33Y 10/00; B33Y 30/00; B33Y 50/02; B29C 67/0092

(57) ABSTRACT

The disclosure concerns a vacuum chamber enclosure configured to contain a 3D printer, the enclosure forms a hermetically sealed environment therein (“vacuum environment”), wherein the 3D printer is configured to perform a 3D printing task and produce a 3D printed object within the vacuum environment, which is an environment that is substantially evacuated of air. Implementations include an vacuum chamber enclosure, a 3D printing system including a vacuum chamber enclosure configured to contain a conventional 3D printer, and a method for 3D printing in a “vacuum environment” wherein a volume within an enclosure containing a 3D printer is substantially evacuated of air.

### BACKGROUND

### Field of the Invention

This invention relates to three-dimensional printers (“3D printers”); and more particularly, to a vacuum-3D printing system having a 3D printer contained within a vacuum chamber enclosure; an enclosure for containing a 3D printer and enabling a 3D printing process within a vacuum environment; and a method for effectuating a 3D printing process within a vacuum environment.

### Description of the Related Art

Three-dimensional printers (“3D printers”) are well known and commercially available. Such 3D printers are generally provided in one of many possible configurations; however, most 3D printers are configured to melt a plastic filament and apply plastic from the plastic filament to build an object on a print bed using an iterative process. For example, a 3D printer generally comprises a print bed, an extruder coupled to a hot end (the hot end may be integrated as part of the extruder), and a multi-axis translation device for translating the print bed, the extruder, or both the print bed and the extruder, such that a small bead of plastic (“pixel”) may be deposited on the print bed, or on the object as it is being printed on the print bed, layer by layer, in successive iteration.

FIG. 1, labeled as “prior art”, shows the essential parts of a conventional 3D printer 100, including: the print bed 101, extruder 102, hot end 103, and multi-axis translation device 104, as well as plastic filament 105 and a filament spool 106.

Because 3D printers are well known, specifics of the 3D printer itself will not be discussed in detail herein. Those having skill in the art would understand the basics of 3D printer technologies, or will be capable of bringing themselves up to speed with minimal review of online and published sources.

While 3D printers have been utilized since as early as the 1980's, the technology has recently become increasingly widespread and available to individual consumers. Accordingly, there is a continued need for improvements related to 3D printers, components for integrating with and improving 3D printers or their associated function, and methods for 3D printing.

### SUMMARY

The disclosure concerns a vacuum chamber enclosure configured to contain a 3D printer, the enclosure forms a hermetically sealed environment therein (“vacuum environment”), wherein the 3D printer is configured to perform a 3D printing task and produce a 3D printed object within the vacuum environment, which is an environment that is substantially evacuated of air.

Implementations include an vacuum chamber enclosure, a 3D printing system including a vacuum chamber enclosure configured to contain a conventional 3D printer, and a method for 3D printing in a “vacuum environment” wherein a volume within an enclosure containing a 3D printer is substantially evacuated of air. Other implementations will be recognized by those having skill in the art.

### BRIEF DESCRIPTION OF THE DRAWINGS

FIG. 1 shows a conventional 3D printer.

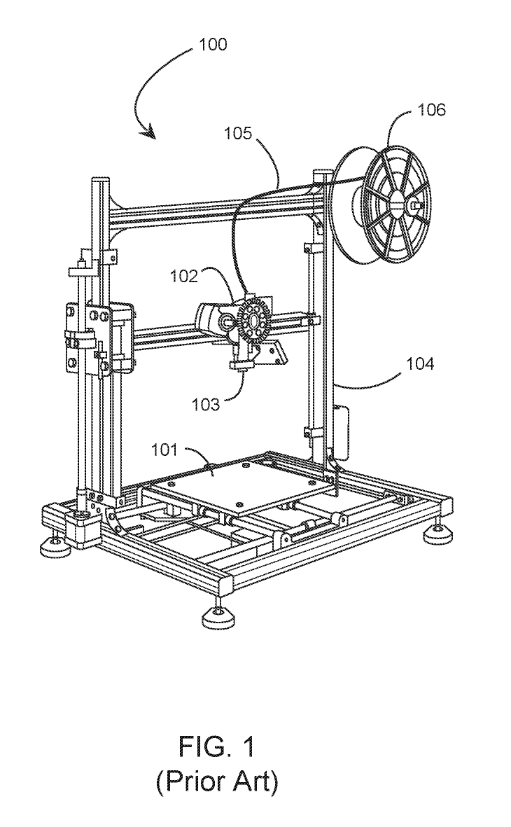

FIG. 2 shows a 3D printing system including a vacuum chamber enclosure configured to contain a conventional 3D printer, the 3D printing system is configured to create a vacuum environment for effectuating a vacuum-3D printing process.

FIG. 3 illustrates a method for 3D printing in a vacuum environment; i.e. the “vacuum-3D process”.

### DETAILED DESCRIPTION OF THE INVENTION

In the following description, for purposes of explanation and not limitation, details and descriptions are set forth in order to provide a thorough understanding of the embodiments of the invention. However, it will be apparent to those skilled in the art that the present invention may be practiced in other embodiments, including certain variations or alternative combinations that depart from these details and descriptions yet arrive at substantially similar results.

For purposes herein, the term “vacuum” is defined as: an environment or volume that is at least partly evacuated of air and perhaps substantially evacuated or air. Such an environment will have a pressure less than 1 atm. It will be understood by those having skill in the art that a true vacuum (an environment that is completely evacuated of air) is unlikely to be achieved, but the term vacuum is not used in its purest sense, rather, a vacuum for purposes herein includes any environment that is at least partly evacuated of air, for example, using a vacuum pump or similar device.

The term “print bed” means: a platen or surface of a 3D printer on which plastic is deposited to form a 3D-printed object.

The term “extruder” means: a component of a 3D printer which delivers plastic filament to a hot end (or nozzle).

The term “hot end” means: a component of a 3D printer which receives plastic filament and melts the filament for depositing a plastic bead (“pixel”) on the print bed or object during a 3D printing process.

The term “multiple axis translation device” is synonymous with “multi-axis translation device”, and means: a device configured to translate a print bed, extruder/hot end, or both the print bed and extruder/hot end, for aligning these components of a 3D printer at each location for depositing a pixel during a 3D printing process. Typically this includes a Cartesian CNC machine; however a Delta machine or other device may be similarly implemented.

The term “hermetically sealed means: airtight, or configured such that airflow is substantially restricted.

The term “vacuum connector” means: any component configured to effectuate the attachment of tubing with a vacuum chamber enclosure for evacuating air within the enclosure.

For purposes herein, the term “vacuum environment” means: an area within an enclosure which is capable of being, or actually is, at least partly evacuated of air or substantially evacuated of air.

In one embodiment, a 3D printing system is disclosed; the 3D printing system comprises a conventional 3D printer enclosed within a hermetically sealed vacuum chamber enclosure, wherein an environment contained within the enclosure is evacuated of air.

In another embodiment, an vacuum chamber enclosure is disclosed, the enclosure is configured to enclose or contain a 3D printer on all sides, and provide a hermetically sealed environment within the enclosure. With the novel enclosure, the 3D printing system is adapted to perform a 3D printing task and produce a 3D printed object from within a “vacuum environment”, or a hermetically sealed environment that is at least partly evacuated of air.

In yet another embodiment, a 3D printing method is disclosed, including the steps: (i) providing an enclosure configured to contain a 3D printer, the enclosure forming a hermitically sealed volume therein; (ii) evacuating air from within the hermetically sealed volume to create a vacuum environment; and (iii) performing a 3D printing task to produce a 3D printed object within the vacuum environment.

Benefits of performing a 3D printing task and producing a 3D printed object within a vacuum environment may include: (i) less energy required to melt plastic at the extruder hot end, since, the melting point of the plastic decreases as pressure decreases and power requirements, temperature, and other factors can be adjusted to reduce energy requirements for operating a 3D printer within an environment that is evacuated of air; and (ii) 3D printed objects can be produced with vacuum pockets, or a completely vacuous interior.

Some products produced using a vacuum-3D printing process will have a lower associated mass compared to the same product produced using a conventional 3D printer and printing process.

With the current advancement of 3D-printed objects that contain an advanced internal structure, combined with the current advancement of 3D-printing materials such as carbon fiber PLA and 3D-printed ceramics, one potentially useful aspect of vacuum-3D printing is the creation of vacuum-balloons, that is, objects that have a large enough internal vacuum to sustain buoyancy or even provide lift. Vacuum balloons have long been sought-after by scientists worldwide, due to the potential to provide hover cars and propellant-less modes of transportation to space.

Other benefits would be possibly implemented in the bio-medical field as bio-materials and implants will be capable of being produced without air pockets, which can be harmful to a patient or otherwise contain various unwanted contaminants.

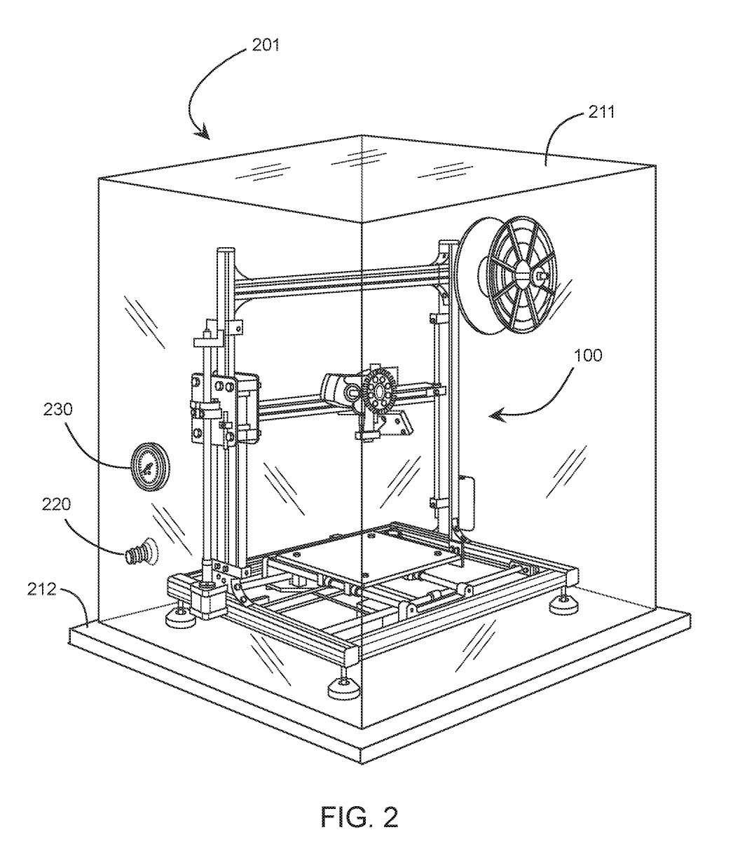

Now turning to the drawings, FIG. 2 shows a 3D printing system including a conventional 3D printer 100 contained within a vacuum chamber enclosure 201. The enclosure is illustrated as a cubic shell having five surfaces, the cubic shell 211 is removeably attached to a base 212 forming a sixth surface, wherein the cubic shell is configured to attach to the base forming a hermetic seal therebetween. A hermetic seal can be implemented using known techniques, for example, a polymer seal, rubber seal, or similar component being disposed between mated edges of the shell and base, or the like.

The enclosure may alternatively be implemented in any fashion which results in containment of the 3D printer, and may include one or more surfaces configured to surround the 3D printer on all sides. For example, a sphere may include one surface, whereas a cube may include six surfaces which surround the 3D printer. The key is to provide a hermetic seal to create a volume within the enclosure that may be substantially evacuated from air.

Moreover, the enclosure may be implemented with sliding doors which are configured to create a similar hermetic seal for containing an environment within the enclosure and pulling a vacuum therein.

Nothing in this disclosure shall be deemed as limiting with respect to the myriad of possible implementations of a vacuum chamber enclosure which functions to contain a 3D printer and achieve a vacuum-3D printing process.

The enclosure may be configured with an aperture (not shown, behind connector), wherein a conventional vacuum connector 220 is coupled at the aperture for providing a mechanism for transferring air and changing or maintaining pressure within the enclosure.

Alternatively, the enclosure may include a molded vacuum connector, or any connector that is otherwise built-in to the enclosure itself. Any other technique may be similarly implemented to provide a mechanism for evacuating air from a volume within the enclosure.

In a preferred embodiment, a vacuum pump is coupled to the vacuum connector of the enclosure via a conduit or tubing extending therebetween, such that the vacuum pump is configured to at least partly evacuate air from within the volume contained within the enclosure.

A vacuum gauge 230 may be implemented on or within the enclosure itself, or otherwise within the vacuum-adapted 3D printing system. The vacuum gauge can be used to monitor the conditions of the vacuum environment surrounding a 3D printer. In this regard, a sensor portion of the vacuum gauge is generally resident within the vacuum environment associated with the enclosure.

In a preferred embodiment, a 3D printing system includes: a print bed; an extruder coupled to a hot end, the extruder configured to receive plastic filament from a filament spool and deliver the plastic filament to the hot end, wherein the hot end is configured to communicate plastic of the plastic filament to the print bed or an object thereon; the print bed, extruder, or a combination thereof being coupled to a multiple axis translation device, wherein the multiple axis translation device is configured to translate the print bed, extruder, or combination thereof (print bed and extruder) to effectuate a 3D printing task and create a 3D printed object fabricated from the plastic of the plastic filament. The 3D printing system is further characterized by: each of the print bed, extruder, and multiple-axis translation device are contained within a hermetically sealed vacuum chamber enclosure, the enclosure comprising at least one vacuum connector for coupling tubing and a vacuum pump or similar vacuum source. In this regard, the 3D printing system is configured to produce the 3D printed object within a vacuum environment associated with the enclosure.

In certain embodiments, a vacuum pressure gauge is implemented, with a sensor portion of the vacuum pressure gauge resident within the vacuum environment associated with the enclosure.

The multiple axis translation device may include a computer numerical control (CNC) unit configured to receive instructions from a computer for translating the print bed, extruder, or a combination thereof (print bed and extruder).

The multiple axis translation device may comprise a three-axis CNC machine, a four-axis CNC-machine, a five-axis CNC machine, or other multiple-axis CNC machine.

The hot end may be integrated to form part of the extruder, or may comprise a separate part coupled to the extruder.

In another embodiment, an enclosure is configured for integration with a 3D printer having a print bed, an extruder coupled to a hot end, the extruder configured to receive plastic filament from a filament spool and deliver the plastic filament to the hot end, wherein the hot end is configured to communicate plastic of the plastic filament to the print bed or an object thereon, the print bed, extruder, or a combination thereof being coupled to a multiple axis translation device, wherein the multiple axis translation device is configured to translate the print bed, extruder, or combination thereof to effectuate a 3D printing task and create a 3D printed object, the enclosure includes: one or more surfaces configured to extend about all sides of the 3D printer, at least one vacuum connector coupled to the one or more surfaces of the enclosure and further configured to couple with a vacuum source, wherein the enclosure is configured to hermetically seal an environment around the 3D printing system such that each of the print bed, extruder, and multiple axis translation device are contained within the hermetically sealed enclosure; and wherein the 3D printing system is configured to produce the 3D printed object within a vacuum-modified environment within the enclosure.

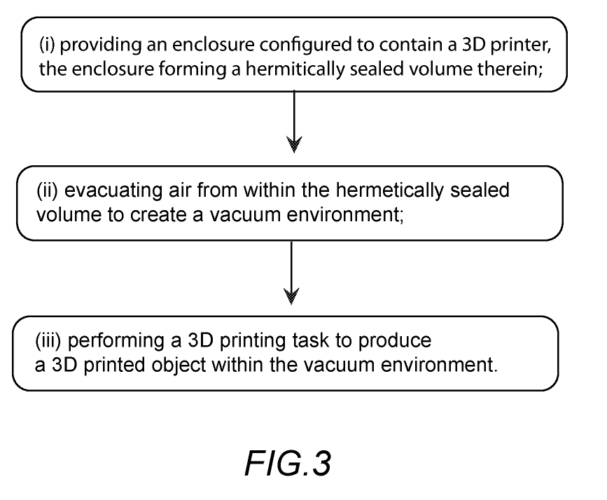

In another embodiment, as illustrated in FIG. 3, a 3D printing method is disclosed, including the steps: (i) providing an enclosure configured to contain a 3D printer, the enclosure forming a hermitically sealed volume therein; (ii) evacuating air from within the hermetically sealed volume to create a vacuum environment; and (iii) performing a 3D printing task to produce a 3D printed object within the vacuum environment.

I claim:

1. A 3D printing system, comprising:
a print bed;
an extruder coupled to a hot end, the extruder configured to receive plastic filament from a filament spool and deliver the plastic filament to the hot end, wherein the hot end is configured to communicate plastic of the plastic filament to the print bed or an object thereon;
the print bed, extruder, or a combination thereof being coupled to a multiple axis translation device, wherein said multiple axis translation device is configured to translate the print bed, extruder, or combination thereof to effectuate a 3D printing task and create a 3D printed object fabricated from said plastic of the plastic filament;
characterized in that:
each of the print bed, extruder, and multiple axis translation device are contained within a hermetically sealed enclosure,
said enclosure comprising at least one vacuum connector, the vacuum connector configured to couple with a vacuum source via tubing extending therebetween;
wherein the 3D printing system is configured to produce the 3D printed object within a vacuum environment created within the enclosure.

2. The 3D printing system of claim 1, further comprising a vacuum pressure gauge, with a sensor portion of said vacuum pressure gauge resident within the vacuum environment of the enclosure.

3. The 3D printing system of claim 1, wherein the multiple axis translation device comprises a computer numerical control unit configured to receive instructions from a computer for translating the print bed, extruder, or a combination thereof.

4. The 3D printing system of claim 1, wherein the hot end is integrated to form part of the extruder.

5. An enclosure configured for integration with a 3D printer, the enclosure comprising:
one or more surfaces configured to extend about all sides of the 3D printer,
at least one vacuum connector coupled to the one or more surfaces of the enclosure and further configured to couple with a vacuum source via tubing extending therebetween,
wherein the enclosure is configured to hermetically seal an environment around the 3D printer such that each of the print bed, extruder, and multiple axis translation device are contained within the hermetically sealed enclosure; and
wherein the 3D printer is configured to produce a 3D printed object within a vacuum-modified environment.

6. A method for effectuating a 3D printing task and creating a 3D printed object, the method comprising:
(i) providing an enclosure configured to contain a 3D printer, the enclosure forming a hermitically sealed volume therein;
(ii) evacuating air from within the hermetically sealed volume to create a vacuum environment; and
(iii) performing a 3D printing task to produce a 3D printed object within the vacuum environment.
